(19) United States
(12) Patent Application Publication
(10) Pub. No.: US 2026/0348884 A1
(43) Pub. Date: Nov. 5, 2026

(54) System and Methods for X-Ray Computed Tomography Based on Adaptive Sensor-Detector Angular Velocity for Matching Scanned Objects and Isocenters by Velocity Modulation

(71) Applicant: Orimtech Ltd., Buffalo Grove, IL (US)

(72) Inventors: Boris S. Goldberg, Buffalo Grove, IL (US); Sergei Gouzeev, Discovery Bay, CA (US)

(73) Assignee: Orimtech Ltd., Buffalo Grove, IL (US)

(21) Appl. No.: 19/664,463

(22) Filed: Apr. 30, 2026

Related U.S. Application Data
(60) Provisional application No. 63/797,407, filed on Apr. 30, 2025.

(51) Int. Cl. G01N 23/046

(52) U.S. Cl. CPC G01N 23/046; G01N 2223/1016; G01N 2223/308; G01N 2223/3301; G01N 2223/3303; G01N 2223/401; G01N 2223/419

(57) ABSTRACT

Methods and systems for tomosynthesis imaging are disclosed which are capable of changing isocenter position to match it with a scanned object by modulation of the angular velocity of an X-Ray source and/or an X-Ray detector during the scanning process. Such modulation (velocity profile) can be calculated a priori if the position of the object is a priori known or defined in real-time by utilizing instant imaging information available during scanning (feedback based). The system includes mounting the X-Ray source and the X-Ray detector on movable platforms (e.g., vehicles or trolleys) to perform the X-Ray scanning.

### RELATED APPLICATION

The present application claims the filing priority of U.S. Provisional Application No. 63/797,407 titled “System and Methods for X-Ray Computed Tomography Based on Adaptive Sensor-Detector Angular Velocity for Matching Scanned Objects and Isocenters by Velocity Modulation,” and filed on Apr. 30, 2025. The '407 application is hereby incorporated by reference.

### FIELD OF INVENTION

The present disclosure relates to both a system and a process for obtaining a series of radiographs from various angular positions with possible/optional conversion into three-dimensional (3D) or tomosynthesis images.

### BACKGROUND OF INVENTION

In many applications based on X-Ray imaging it is mandatory to capture multiple views of the imaged object from different angles. This requires the movement of an X-Ray source (i.e., emitter or source) and an X-Ray detector (i.e., detector) to follow some trajectories maintaining the imaged object within the field of view (FOV). While moving along the trajectories, the system (i.e., source-detector pair) captures two-dimensional (2D) X-Ray images (conventionally referred to as “radiographs”) in a sequence of positions: P0, P1, . . . ,PN, where N≥2, and often has a magnitude of a few thousands. During this process (conventionally referred to as “X-Ray scanning”) the system (i.e., source-detector pair) is rotated around some point known as the “isocenter.” The “isocenter” is defined as a fixed point in 3D space that remains stationary while the treatment machine moves around it.

When imaging an object, the system has to keep the same isocenter for all capturing positions (P0, P1, . . . ,PN) having the scanned object at that isocenter. Not having the object in the isocenter causes the absence of the object within the FOV completely or partially at certain positions. This absence makes conversion of the 2D series images into 3D or tomosynthesis images (via 3D reconstruction) very difficult, if not impossible.

To illustrate, FIGS. 1 and 2 can be contrasted with FIGS. 3 and 4. FIGS. 1 and 2 show an object placed at the isocenter for scanning. In this illustration, as the source and detector revolve around the isocenter, the object is present in every acquired image. However, FIGS. 3 and 4 illustrate a situation where the object to be scanned and the scanning isocenter are substantially mismatched. In this case, the object may not be presented (completely or partially) in some acquired views. The conventional approach considers the isocenter as predefined once the detector/source trajectories are set.

With the current scanning technology, it is mandatory to align/match the object position and isocenter. During such alignment, one needs to either move the isocenter to match the object (i.e., by manipulating the position of the scanning system) or move the object to match the isocenter. In most cases, moving the isocenter to match the object is realized by physical translation of the detector and the source trajectories. It is understood that both approaches are applied equally often. At the same time, for many specific applications, both approaches are also equally inconvenient or complicated to implement.

For example, most cone-beam dental scanners (e.g., iCAT™ System, manufactured by DEXIS, Inc.) have a predefined isocenter within the system trajectory plane. If a scanned area of interest changes, then a technician (e.g., doctor) is placing the patient's head in a different position. Another example is known as a C-Arm system with the ability to make a cone-beam 3D image (e.g., Cios Spin™, manufactured by SIEMENS HEALTHCARE). For clinical applications assuming 3D imaging, a user has to match the isocenter and object by moving the system.

Accordingly, it would be useful to have a system in which the isocenter is not fixed at one point in 3D space. The system and methods disclosed herein allow for a dynamic isocenter which is determined by changing the trajectory configuration for one or both the source and the detector of the scanning system.

Until the invention of the present application, these and other problems in the prior art went either unnoticed or unsolved by those skilled in the art. The present inventions provide a scanning system which performs desired functions in accordance with the disclosed methods without sacrificing efficiency, accuracy, or usefulness.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1. is a prior art system for scanning an object placed at its isocenter. The detector and source move with constant angular speed. The scanned object is within the isocenter of the scanning system and therefore the acquired image as well.

FIG. 2. is the prior art system for scanning an object placed at the isocenter as shown in FIG. 1. The detector and source are shown in new locations as they move with constant angular speed. The scanned object remains in the center of the acquired image.

FIG. 3 is the prior art scanning system of FIG. 1 where an object is placed outside of the isocenter. The detector and source move with constant angular speed. The scanned object is not in the center of the acquired image, but still within the field of view (FOV).

FIG. 4 is the prior art scanning system of FIG. 3 with the object placed outside of the isocenter. The detector and source have moved to another position resulting in the scanned object being outside the field of view (FOV).

FIG. 5 illustrates a scanning system in accordance with the disclosed invention where the object to be scanned is placed outside of the system isocenter. The X-Ray detector and the X-Ray source, beginning in first locations, move with modulated angular speed and the scanned object is maintained in the center of the acquired image.

FIG. 6 further illustrates the scanning system of FIG. 5 with the object still placed out of the isocenter. The detector and source are in second locations, moving with modulated angular speed. The scanned object is maintained within the center of the acquired image.

FIG. 7 illustrates still further the scanning system of FIG. 5 with the object remaining out of the isocenter. The detector and source are in third locations, moving with modulated angular speed. The scanned object is maintained within the center of the acquired image.

FIG. 8 illustrates superimposed scanned object images at time t0 and t1.

FIG. 9 depicts an embodiment of the disclosed system having two independently movable platforms or mechanisms (e.g., trolleys) for carrying the detector and the source, while also illustrating a computer system which controls the trolley motion, the detector, and the source.

FIG. 10 illustrates scanning of the object (P) with source(S) moving (e.g., positions S0 and S1) and the detector (D) moving (e.g., positions D0 and D1) along a priori known predefined arbitrary trajectories TD and TS.

FIG. 11 illustrates the disclosed system maintaining the scanned object projection at the center of the acquired image.

### SUMMARY OF THE INVENTION

There is disclosed herein an improved X-Ray Scanning system and methods which avoid disadvantages of prior systems and methods while affording additional structural and operating advantages.

Generally speaking, the invention comprises a novel method of changing isocenter position (therefore matching it with the scanned object) by modulation of the angular velocity of X-Ray source or X-Ray detector or both during the scanning process. Such modulation (velocity profile) can be:
calculated a priori if the position of the object is a priori known;
or defined in real-time by utilizing the instant imaging information available during scanning (feedback based).

The invented system comprises the X-Ray source, X-Ray detector and the scanned object. X-Ray source and X-Ray detector are mounted on movable platforms (e.g., vehicles or trolleys) performing the X-Ray scanning. Trolleys are the part of the invented system. During such scanning the source and detector (mounted on a dedicated vehicle/trolley each) are moving along a priori known and predefined trajectories. The system also comprises the computer 20 with means for:
controlling the position and velocity of the detector and source at every moment of time;
saving and processing the X-Ray images acquired by X-Ray detector during the scanning process.

The trajectories can be any shape allowing imaging the object from different angles. Which means that:
For any position of the source on the radiation source trajectory the source is capable of irradiating the scanned object
For any position of the radiation source, a corresponding detector position can be found such that the scanned object is present in full in the image acquired by the detector.

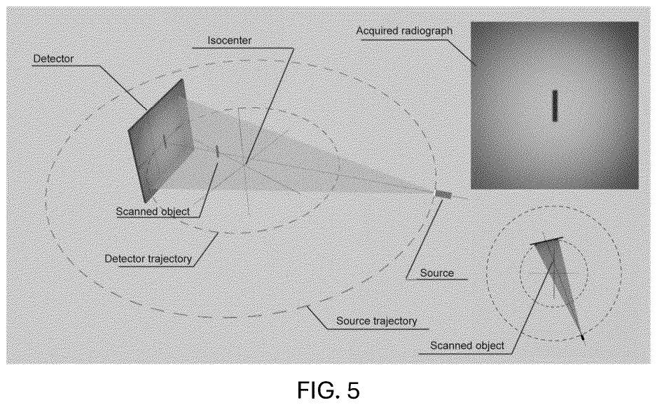

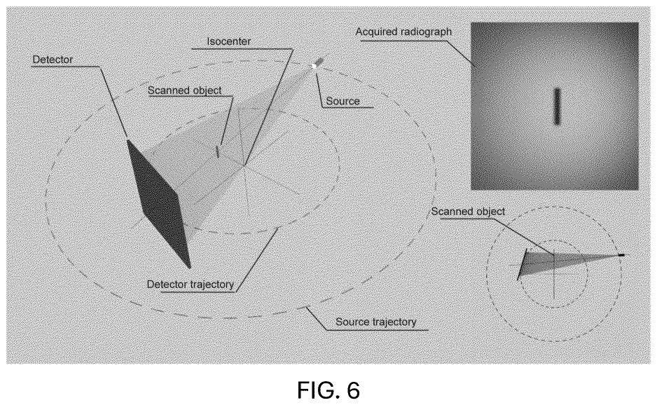

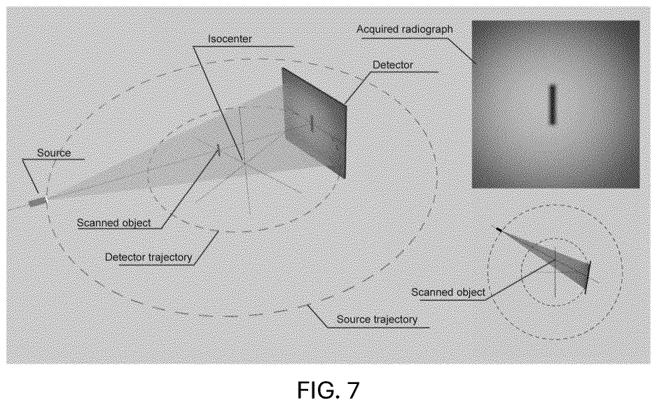

During the scanning motion the computer is defining the velocity and positions of trolleys in correspondence with the computer 20 implementation of the invented method. The method and the system implementing the method are illustrated in FIGS. 5-7.

If the positions of the object and isocenter are a priori known then it is possible to calculate the source and detector positions (thus, a velocity profile) for keeping the scanned object in the center of field of view at every moment of the scan.

If the positions of either object or isocenter are a priori unknown then the system is adjusting the velocity of either detector or source or both by detecting the object projection change in the acquired images.

In order to maintain the scanned object projection at the center of the acquired image the system performs real-time modulation of the angular velocity according to the following formula.

Vₜ₂=Vₜ₁+ΔV=Vₜ₁+F(Pₜ₀,Pₜ₁)∥Pₜ₂−P_{c}|→min (3.1)

Where,
Vₜ₂ is the angular velocity at the moment of time t2
Vₜ₁ is the angular velocity at the moment of time t2
ΔV is the applied change (acceleration or deceleration)
(Pₜ₀, Pₜ₁) are positions of the scanned object projection on the detector plane at the moments t0 and t1
F(Pₜ₀, Pₜ₁) is the function defining the value of ΔV
P_{c} is the center of the detector

These and other aspects of the invention may be understood more readily from the following description and the appended drawings.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

### 5.1 Existing Problem

In many applications based on X-Ray imaging it is mandatory to capture multiple views of an imaged object from different angles. The range of required/applied angles may vary but will typically fall within the range of from about 15 to about 360 degrees. That is, the multiple views taken will fall within a range, for example, of as little as a 15-degree arc about the object to as much as a full 360 degrees. Each image is separated by an increment which can be roughly estimated based on travel distance, speed, and the number of images obtained.

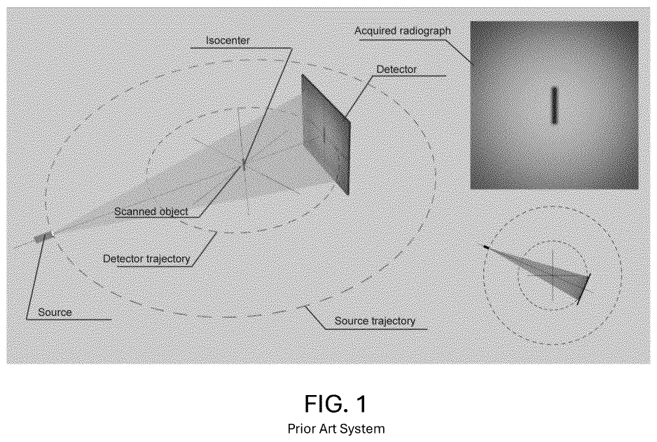

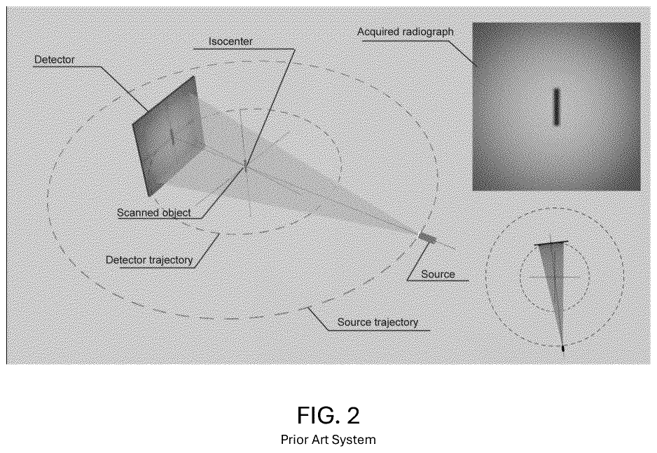

Referring to FIGS. 1-2, a system and method of the prior art is illustrated. The current prior art process requires an X-Ray source (the source) and an X-Ray detector (the detector) to follow a trajectory (T_{S}—source trajectory, T_{D}—detector trajectory) while maintaining the imaged object (O) within the field of view (FOV). In other words, the object (O) has to be projected in full on the X-Ray detector for every acquired radiograph. While moving along the trajectories, the system (source-detector pair) is capturing 2D X-Ray images (radiographs) at numerous positions P0, P1, . . . ,PN, where N ranges from 2 to a few thousand. During this process (called X-Ray scanning) the pair source-detector rotate in 180° alignment around a point called the isocenter. For imaging the object (O), the pair has to keep the same isocenter for all capturing positions P0, P1, . . . ,PN with the scanned object at the isocenter.

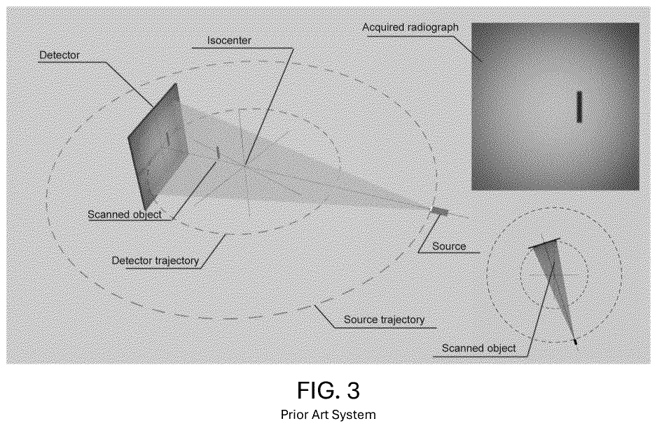

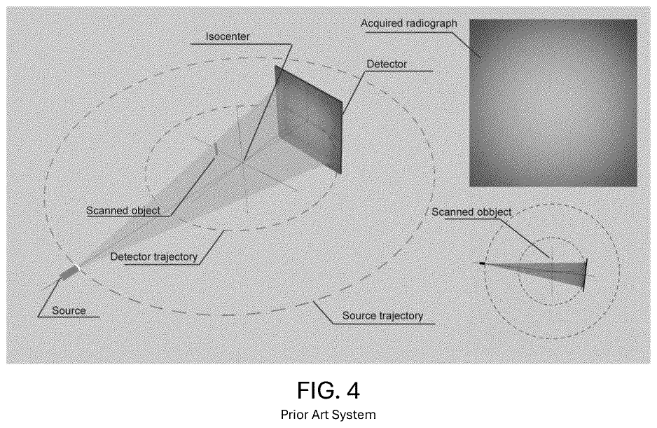

As shown in FIGS. 3 and 4, not having the object in the isocenter causes a misalignment of the object on the detector (FIG. 3) and the complete absence of the object within FOV (FIG. 4). That is, as shown in FIG. 3, with the object in the FOV, but not at the isocenter, the resulting captured images will misalign when 3D reconstruction is attempted. When the object is neither at the isocenter nor within the FOV, as illustrated in FIG. 4, the object will not be captured in the resulting radiograph. These problems make conversion of 2D series images into a 3D or tomosynthesis image (3D reconstruction) very difficult, if not impossible.

Typically, the trajectory configurations define the isocenter position since the positions of the detector and source within the scanning time would be predefined. For example, with a circular trajectory of the source-detector pair, the isocenter is the center of the circular path. However, the only way to align the isocenter and the object to be scanned is by moving either the object or the trajectories of the source-detector pair-thus the isocenter. There are applications where both ways are inconvenient or even barely possible. In many cases the scanning system may not support trajectory adjustment leaving only object adjustment as an option. One example is a floor-mounted equine extremity scanner VisionCT™ from Hallmarq. In the case of scanning a horse extremity (e.g., the rear leg) it is, practically speaking, very complicated to adjust the object (i.e., the rear leg) to the required position, as it requires moving a much larger portion of the entire horse, if not the entire horse.

### 5.2 System

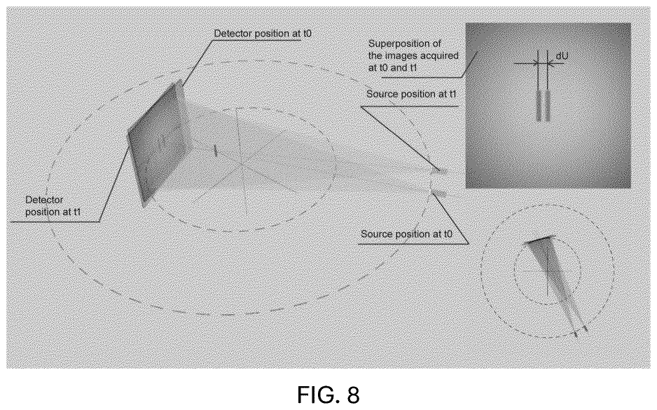

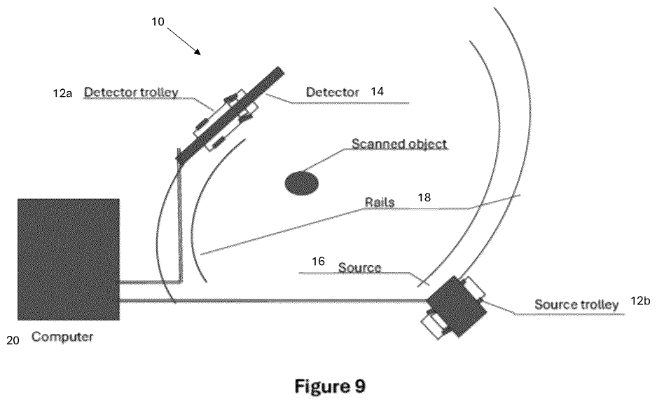

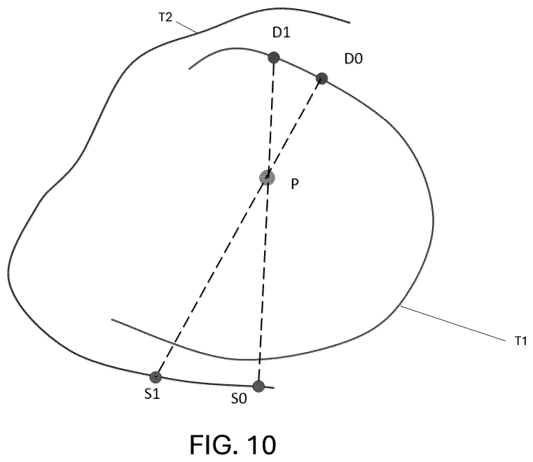

With reference to FIGS. 5-11, embodiments of the disclosed system 10 and methods are illustrated. In a preferred embodiment, the system 10 comprises first and second vehicles, 12a and 12b respectively (also referred to as trolleys 12a and 12b herein), with the first vehicle 12a carrying an X-ray detector 14 and the second vehicle 12b carrying an X-ray source 16. The two trolleys 12a and 12b move around the scanned object with each maintaining a predefined a priori known trajectory. In order to maintain the two trajectories, T1 and T2, the system may include rails 18 onto which the two trolleys 12a and 12b move.

The trajectories, T1 and T2, can be any shape allowing imaging of the object from different angles. That is, by “predefined a priori known” it is meant that for any position of the source 16 on the radiation source trajectory T2 the source 16 is capable of irradiating the scanned object, and for any position of the radiation source 16, a corresponding detector position can be found such that the scanned object is present in full in the image acquired by the detector 14. The trajectory of the two trolleys 12a and 12b, and therefore the source 16 and detector 14, may be controlled in various ways, including guide rails, static (fixed) wheel configuration, dynamic wheel control “on a fly”, remote computer control, and other similar ways which may be understood by those of skill in the art.

The preferred embodiment of the disclosed system 10 also comprises a computer 20 with means of:
controlling the position and velocity of the detector 14 and source 16 at every moment of time;
controlling the operation of the X-ray source 16 and the X-ray detector 14; and
saving and processing the X-ray images acquired by the X-ray detector 14 during the scanning process.

### 5.3 Angular Velocity Modulation in the Case of a Priori Known Trajectories and a Priori Known Object Position

The sufficient conditions of making a scan are as follows:
Condition of maintaining isocenter. The object position (X_{P}, Y_{P}) always belongs to a line connecting the source 16 and the detector 14 positions, as related in equations 4.1 and 4.2 below.

$${X}_{D} = {F}_{x} ( {X}_{S} , {Y}_{S ,} {X}_{P} , {Y}_{P} ) \vert \frac{( {Y}_{S} - {Y}_{D} )}{( {X}_{S} - {X}_{D} )} = \frac{( {Y}_{P} - {Y}_{D} )}{( {X}_{P} - {X}_{D} )} , \\ ∀ ( {X}_{S} , {Y}_{S} ) ∈ TS , ∀ ( {X}_{D} , {Y}_{D} ) ∈ TD \qquad ( 4.1 )$$

$${Y}_{D} = {F}_{y} ( {X}_{S} , {Y}_{S ,} {X}_{P} , {Y}_{P} ) \vert \frac{( {Y}_{S} - {Y}_{D} )}{( {X}_{S} - {X}_{D} )} = \frac{( {Y}_{P} - {Y}_{D} )}{( {X}_{P} - {X}_{D} )} , \\ ∀ ( {X}_{S} , {Y}_{S} ) ∈ TS , ∀ ( {X}_{D} , {Y}_{D} ) ∈ TD \qquad ( 4.2 )$$

Condition of continuity. Any small change of the position of the source 16 causes a small change of the detector 14 position and vice versa, as related in equations 4.3 and 4.4 below.

$$Δ D = ‖ {X}_{D 1} - {X}_{D 0} , {Y}_{D 1} - {Y}_{D 0} ‖ {\to }_{Δ S = ‖ {X}_{S 1} - {X}_{S 0} , {Y}_{S 1} - {Y}_{S 0} ‖ \to 0} 0 \vert ∀ ( {X}_{S} , {Y}_{S} ) ∈ TS , ∀ ( {X}_{D} , {Y}_{D} ) ∈ TD \qquad ( 4.3 )$$

$$Δ S = ‖ {X}_{S 1} - {X}_{S 0} , {Y}_{S 1} - {Y}_{S 0} ‖ {\to }_{Δ D = ‖ {X}_{D 1} - {X}_{D 0} , {Y}_{D 1} - {Y}_{D 0} ‖ \to 0} 0 \vert ∀ ( {X}_{S} , {Y}_{S} ) ∈ TS , ∀ ( {X}_{D} , {Y}_{D} ) ∈ TD \qquad ( 4.4 )$$

Once the velocity (linear along the trajectory or angular) of either the detector 14 or the source 16 is defined, the velocity of the opposite device (source 16 or detector 14) is calculated according to equations 4.1 and 4.2 above.

### 5.4 the Algorithm of Angular Velocity Modulation in the Case of Circular Trajectories and a Priori Known Object Position

If the positions of the object and isocenter are a priori known, then it is possible to calculate the source 16 and detector 14 positions (thus, a velocity profile) for keeping the scanned object in the center of field of view at every moment of the scan. For a circular trajectories case, the following conditions are assumed:
Both the detector 14 and the source 16 have a circular trajectory with the same center at X₀=0 and Y₀=0;
The scanned object is located at the point (X₁, Y₁);
The radius of the detector trajectory is R_{d};
The radius of the source trajectory is Rₛ; and
The source 16 is moving with a constant angular speed (V_{S}) and starts its motion at the angle A=0.

Based on those assumptions, then the position of the source 16 at moment tis identified by the following two equations, 4.5 and 4.6:

X_{s,t}=Xₛ(t)=X₂=Rₛ*cos(t*Vₛ) (4.5)

Y_{s,t}=Yₛ(t)=Y₂=Rₛ*sin(t*Vₛ) (4.6)

The optimal position of the detector center is the point where the line connecting the object at (X₁, Y₁) and the source 16 at (X₂,Y₂) is crossing the detector trajectory. This point (X_{d,t}, Y_{d,t}) can be found as follows:

$${d}_{x} = {X}_{2} - {X}_{1} \qquad ( 4.7 )$$

$${d}_{y} = {Y}_{2} - {Y}_{1} \qquad ( 4.8 )$$

$${d}_{r} = \sqrt{{d}_{x}^{2} + {d}_{y}^{2}} \qquad ( 4.9 )$$

$$D = {X}_{1} {Y}_{2} - {X}_{2} {Y}_{1} \qquad ( 4.1 )$$

$${X}_{d , t} = {X}_{3} = \frac{{Dd}_{y} \pm sign ( {d}_{y} ) {d}_{x} \sqrt{{R}_{d}^{2} {d}_{r}^{2} - {D}^{2}}}{{d}_{r}^{2}} \qquad ( 4.11 )$$

$${Y}_{d , t} = {Y}_{3} = \frac{- {Dd}_{x} \pm \vert {d}_{y} \vert \sqrt{{R}_{d}^{2} {d}_{r}^{2} - {D}^{2}}}{{d}_{r}^{2}} \qquad ( 4.12 )$$

Then the angular detector position as a function of time is identified as:

$${A}_{d} ( t ) = {tan}^{- 1} ( \frac{{Y}_{d , t}}{{X}_{d , t}} ) \qquad ( 4.13 )$$

### 5.5 the Velocity Modulation Based on the Imaged Object Position within Field of View

For maintaining the scanned object projection at the center of the acquired image the system performs real-time modulation of the angular velocity according to the above formula (3.1), reproduced again below:

Vₜ₂=Vₜ₁+ΔV=Vₜ₁+F(Pₜ₀,Pₜ₁)∥Pₜ₂−P_{c}|→min

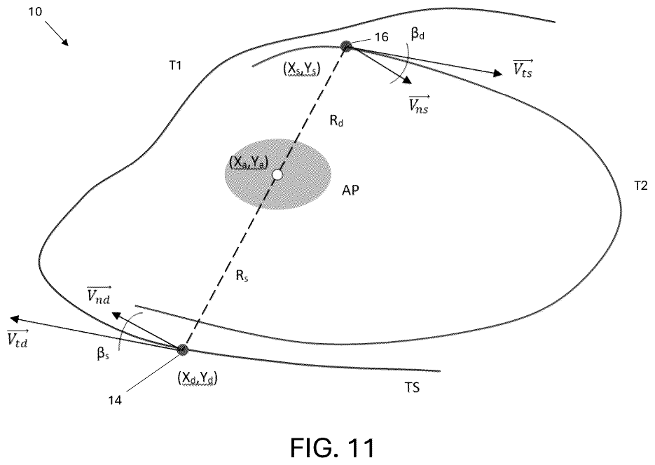

Referring to FIG. 11, the following variables are of interest:
TS—predefined source trajectory
TD—predefined detector trajectory
AP—the area where the scanned object can be potentially placed
(Xₐ, Yₐ)—center (mass-center) of AP
(Xₛ, Yₛ)—position of the source, (Xₛ, Yₛ)∈TS
(X_{d}, Y_{d})—position of the detector, (X_{d}, Y_{d})∈TD
Rₛ—distance between (Xₐ, Yₐ) and (Xₛ, Yₛ)
R_{d}—distance between (X_{d}, Y_{d}) and (Xₛ, Yₛ)
\vec{V_{nd}}—normal to a straight line {(X_{d}, Y_{d}), (Xₛ, Yₛ)} at the point (X_{d}, Y_{d})
\vec{Vₙₛ}—normal to a straight line {(X_{d}, Y_{d}), (Xₛ, Yₛ)} at the point (Xₛ, Yₛ)
\vec{V_{td}}—tangent to a curved trajectory TD at the point (X_{d}, Y_{d})
\vec{Vₜₛ}—tangent to a curved trajectory TD at the point (Xₛ, Yₛ)
βₛ—angle between \vec{Vₙₛ} and \vec{V_{nd}}
β_{d}—angle between \vec{Vₜₛ} and \vec{V_{td}}

The function F( . . . ) has to be defined. In order to do that, it is assumed that the area where the scanned object can be placed is restricted and predefined. This is the area AP in FIG. 11 with its mass center in the point (Xₐ, Yₐ). Obviously for keeping (Xₐ, Yₐ) as the isocenter we have to maintain the linear velocities at the points (Xₛ, Yₛ) and (X_{d}, Y_{d}) according to the following equation:

$$\frac{{V}_{td} * cos ( {β}_{d} )}{{R}_{d}} = \frac{{V}_{ts} * cos ( {β}_{s} )}{{R}_{s}} \qquad ( 4.14 )$$

$$- or -$$

$${V}_{td} = {V}_{ts} * \frac{cos ( {β}_{s} ) * {R}_{d}}{cos ( {β}_{d} ) * {R}_{s}} \qquad ( 4.15 )$$

where V_{td} and Vₜₛ are linear velocities of the detector and the source correspondingly.

If Φ is the frame rate (frames per second), then the formula (3.1) can be represented as the following:

$${V}_{td 2} = {V}_{td 1} - Φ * Δ V = {V}_{td 1} - \frac{Φ * Δ D}{cos ( {β}_{d} )} \qquad ( 4.16 )$$

ΔD is the difference between the positions of the scanned object and the detector center.

### 5.6 the Position of Object on the Acquired Image

Two cases have to be considered:
(1) the scanned object is the only object inside the field of view; and
(2) acquired radiographs (at least some of them) contain several objects and only one of them is the scanned one.

If the field of view (thus, all radiographs) contains only the scanned object, then the position of the object on the radiograph is the mass center of the shadow—i.e., the captured image. If an acquired radiograph contains multiple objects, then the center of the scanned object is calculated as the mass center of a set of metal markers attached to the scanned object. The method of detecting the markers is described in the U.S. Pat. No. 11,099,140, the entirety of which is incorporated herein by reference.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method of performing X-ray computed tomography on an object, comprising:
mounting an X-ray source on a first movable trolley which moves along a first trajectory about an object to be scanned;
mounting an X-ray detector on a second movable trolley which moves about the object to be scanned along a second trajectory;
moving the first movable trolley about the object along the first trajectory while the X-ray source emits radiation directed toward the object;
moving the second movable trolley about the object along the second trajectory while capturing a plurality of 2-dimensional views (radiographs) by the X-ray detector;
wherein movements of the first movable trolley with the X-ray source and the second movable trolley with the X-ray detector are coordinated such that the position and angle of the X-ray detector relative to the X-ray source maintains the object in a field of view.

2. The method of claim 1, wherein the first trajectory and second trajectory for each of the first and second movable trolley is defined by a first rail and a second rail, respectively.

3. The method of claim 2, wherein maintaining the object in the field of view prevents the need for relocation of the object during scanning.

4. The method of claim 2, wherein maintaining the object in the field of view prevents the need for relocation of the scanning trajectories of the source and detector.

5. The method of claim 4, wherein maintaining the object in the field of view further comprises motion velocity modulation of the first and second trolleys.

6. A system for performing X-ray computed tomography on an object, comprising:
an X-ray source mounted on a first movable trolley which moves along a first trajectory about an object to be scanned;
an X-ray detector mounted on a second movable trolley which moves about the object to be scanned along a second trajectory;
a controller connected to both the first movable trolley and the second movable trolley to operate each along the respective trajectory;
wherein the first movable trolley moves about the object along the first trajectory while the X-ray source emits radiation directed toward the object, and the second movable trolley moves about the object along the second trajectory while capturing a plurality of 2-dimensional views (radiographs) by the X-ray detector; and
wherein movement of the first movable trolley with the X-ray source and movement of the second movable trolley with the X-ray detector are coordinated such that the position and angle of the X-ray detector relative to the X-ray source maintains the object in a field of view.

7. The system of claim 6, further comprising software loaded on the computer for converting the plurality of 2-dimensional views into a 3-dimensional image.

8. The system of claim 6, further comprising a first track on which the first movable trolley moves, wherein the first track follows the first trajectory.

9. The system of claim 8, further comprising a second track on which the second movable trolley moves, wherein the second track follows the second trajectory.

10. The system of claim 8, wherein control of the first and second trolleys comprises motion velocity modulation of the first and second trolleys.
